(19) United States
(12) Patent Application Publication
(10) Pub. No.: US 2006/0271669 A1
(43) Pub. Date: Nov. 30, 2006

(54) Method of collecting data regarding a plurality of web pages visited by at least one user

(75) Inventors: Megan Bouguenon, Highgate West (ZA); Steven Liversedge, President Park (ZA); Victor Bouguenon, Carlswald (ZA)

Correspondence Address: NIXON PEABODY, LLP, 401 9TH STREET, NW, SUITE 900, WASHINGTON, DC, 20004-2128, US

(73) Assignee: CUBICICE(PTY) LTD, Fourways (ZA)

(21) Appl. No.: 10/559,579

(22) PCT Filed:
(86) PCT No.: PCT/IB04/01812

(51) Int. Cl. G06F 15/173

(52) U.S. Cl. 709/224

(57) ABSTRACT

A method of collecting data regarding a plurality of web pages visited by at least one user. The method comprises the steps of receiving, at a server, identification data together with web page data, wherein the identification data identifies a website access device of a user and the web page data identifies a web page which the user has viewed using the website access device. The identification data and the web page data are stored in a database. In addition, personal data of a plurality of users are stored, the personal data including a unique identifier of each user. A request is received from a user to view a web page, the request including a unique identifier of the user and identification data identifying the website access device used by the user. The unique identifier and identification data from the request are used to retrieve the user's personal data and to link the web page data to the user. A tracking script may be inserted into the code of a web page to communicate identification data and/or unique identifier data to the server.

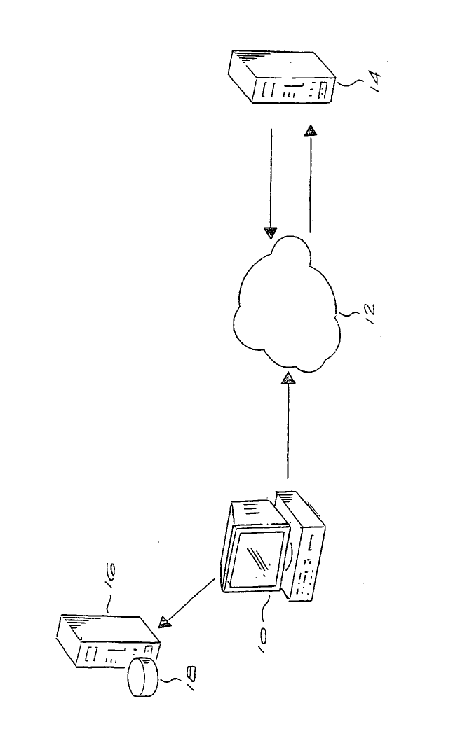

### BACKGROUND OF THE INVENTION

THIS invention relates to a method of collecting data regarding a plurality of web pages visited by at least one user via the Internet or an intranet.

The present invention is in response to the business requirement to acquire and retain customers as well as build relationships with other business stakeholders, combined with a growing trend to use the Internet and computer networks as a communication tool by way of e-mail and/or website. E-mails and websites are used by various businesses to interact with defined target markets and business stakeholder groups. Businesses require as much information as possible indicating how specific individuals and target markets respond to initiatives to communicate and conclude business through the Internet, such as e-mail and websites.

Previously, e-mail and website owners have only been able to obtain data such as the number of visits to a website or to particular pages on the website. However, without the website user sharing information, or identifying themselves through a login process or accessing information on the device being used to view a website, further personal information about the user is not obtainable.

The ability to identify and match an individual with website interactivity is desirable in that it provides demographic information and important website interaction information relating to the response of individuals, the target market and website users in general.

The present invention seeks to address this.

### SUMMARY OF THE INVENTION

According to the present invention there is provided a method of collecting data regarding a plurality of web pages visited by at least one user, the method comprising the steps of:
receiving, at a server, identification data together with web page data, wherein the identification data identifies a website access device of a user and the web page data identifies a web page which the user has requested to view using the website access device;
storing the identification data and the web page data in a database;
storing personal data of a plurality of users, the personal data including a unique identifier of each user;
receiving a request from a user to view a web page, the request including a unique identifier of the user and identification data identifying the website access device used by the user; and
using the unique identifier and identification data from the request to retrieve the user's personal data and to link the web page data to the user.

The unique identifier may be at least one of a user's name, e-mail address or a unique identifier generated for the user.

Preferably, the request from the user is generated from an email communication or identifiable interaction with the website such as the completing of an online form or the requesting of a web page through a website access device or internet browser.

A tracking script may be inserted into the code of a web page to communicate identification data and/or unique identifier data to the server.

The invention further comprises sending an e-mail to a plurality of users, the e-mail including a link to further information available within the e-mail or alternatively a requested web page therein, wherein the request from the user to view the information or requested web page is generated by the user selecting the link.

Preferably, once the user has selected the link, the user's request is routed first to the central server before being redirected to the requested web page or alternatively information relating to clicking on the link is shared with the server.

The method may comprise the step of providing a user with the capability to verify if their interactions with a website are being tracked as an identifiable user and accordingly opt out from the identification and tracking process.

Preferably, a plurality of website access devices are associated with a single individual and therefore provide collective web page data on the individual.

### BRIEF DESCRIPTION OF THE DRAWINGS

The accompanying FIGURE is a schematic representation of the system within which the present invention operates.

### DESCRIPTION OF AN EMBODIMENT

Referring to the accompanying drawing, a user wishing to visit a website uses a website access device typically in the form of a personal computer (PC) 10 to access, via the Internet 12, a web server 14.

It will be appreciated that the website access device could also be a mobile telephone, personal digital assistant (PDA), television, computer work station or touch screen device used to access a website.

The web server 14 downloads a script onto the PC 10 typically in the form of a Java script contained in a web page to ascertain whether or not the PC has previously been used to access the server 14.

If the user has not accessed the web server 14, identification data in the form of an identification cookie is created and downloaded onto the PC 10. The identification data identifies the website access device. If an identification cookie exists, or after the identification cookie has been created, web page data together with the identification cookie data are transferred to a server 16 with an associated database 18. Server 14 and 16 can be one and the same server.

The identification data and the web page data are stored in the database 18.

The script is used to identify and record when the web visitor uses the website access device to access a website or more specifically when the user requests access to one or more web pages contained in the website. Furthermore, the script can be used to record additional data relating to the interaction process such as browser information.

In either case, each time the user accesses the website or particular web pages, data is transmitted to the server 16 and stored together with the cookie identification data. In this manner, a history is built of what web pages are accessed by the web visitor. The server that hosts the invention is set up to track and report on defined websites and or web pages.

Practically, the abovementioned is implemented by inserting and or appending a tracking script into each web page which the website owner wishes to identify as having been visited. This tracking script is inserted and or appended to the web page using an application specifically designed for the purpose of inserting the script into static web pages and or appending the script to dynamically generated web pages. The script is embedded into the web page, and is returned to the web visitors Internet browser, thus allowing the script to communicate with the server 16 every time a web page is served to a web visitor's Internet browser thus recording website interactivity against the identification cookie.

In addition, personal information is transmitted to the server 16 by a website owner or associated party. This additional information is in the form of personal data of a plurality of users which may be a plurality of customers or any other business stakeholder of the website owner. The personal data at a minimum includes at least a unique identifier such as the user's name, email address or a unique identifier generated for the user or by the user, but typically includes more information such as company information, designation, contact details such as fax, phone and postal address. Also included for each user are visitor contact types such as:

Customer type A

Customer type B

Training type A

Training type B

Potential customer

Partner

Distributor

Media

E-mail newsletter A

E-mail newsletter B

Mailing list A

Mailing list B

It is possible for each contact to be included in more than one contact type with the number of contact types being only limited by the inventions practical display limit. As will be described later, each contact also has the identification cookie number and web interaction history associated therewith.

In order to correlate web interaction history with personal information the following is carried out. Firstly, various e-mail correspondence is sent out to different contact types with the e-mail typically including some background information and then a link to a particular web page which the mail recipient is encouraged to visit.

For example, the e-mail may begin with an introduction about a particular product and then encourage the user to click on the link for further information or to purchase the product.

If the e-mail recipient clicks on the link, a request is received at the central server 16 to view the requested web page. The request includes the unique identifier such as the e-mail address of the recipient together with identification data identifying the website access device of the user. The identification data takes the form of the identification cookie which has previously been placed on the user's computer.

Once the central server 16 receives the request, the central server uses the unique identifier such as the e-mail address and the identification data from the request to retrieve the users personal data and to link the previously stored web page data to the user (e-mail recipient).

The user is then redirected to the requested web page.

In practice, this method is implemented by the website owner sending a request to the server 16 to insert a web page link into an e-mail. The server 16 replaces the end destination link with a different link to re-route the request first to the server 16 before the request is redirected to the final destination.

It will be appreciated that the user's personal information can now be linked to their website history giving the website owner a complete picture rather than merely knowing that an anonymous user has been visiting their site on various occasions. Furthermore it is now possible to track future direct visits to the website as visitor identified interactions.

In essence known users are matched from the click through thereby identifying the cookie with the contact. Thereafter, the individual is traced as a known user, and the server 16 will be able to provide ongoing tracking and reporting.

The identification cookie described above is based on the domain name of the sender and not the entire URL of the sender. This is because if the URL changes or is typed in different case, a new cookie will be created based on a new URL.

It will be appreciated that a user's computer will in any event have a number of unique identification cookies thereon with each cookie being related to one of a number of domains. The invention has the ability to associate more than one device with an individual thus allowing the invention to track and record individual website interactivity over numerous devices.

The above methodology is used to collect data on both identified and unidentified website users which can then be reported to the business concerned in a number of different ways. Information which can be extrapolated includes the recency of visits, the latency of visits, the frequency of visits, individual pages accessed, demographics, user browser information, user clickstream paths, website interaction intervals, non-interaction by defined parties and link tracking reports to mention a few of the reporting options available. Information can also be grouped according to contact list type or alternatively according to input page URL, referring URL etc. The information is typically supplied from the central server 16 and database 18 to the business owner either by e-mail, pre-packaged reports, downloading of data into analysis applications, transfering data to other business related databases or by the business owner accessing the server 16 via the Internet, for example.

The invention has the added capability of providing website visitors both identified and unidentified with the ability to verify and opt out if required from the identification and tracking process.

This is accomplished by the invention generating a website specific scripting code, which the invention user would include in email communications or on web pages. The scripting code provides a link to a web page generated by the invention. A website visitor would typically click on the link and be provided access to the generated web page.

By entering information such as name, company details or email address into a form included in the web page, the website visitor would be able to submit said information and verify if they have been identified by the invention, as it relates to the website tracking process. The invention typically compares information submitted, with information stored in the database and verifies if identification has taken place.

Furthermore if identification has taken place the website visitor is provided the functionality via the generated web page to opt out of the identification process if required. Selecting to opt-out instructs the invention to convert existing as well as future identification data to unidentified data with all website interactions being reported as unidentified actions.

In any event, it will be appreciated that the information can provide business with information to satisfy the following needs:
Understand both individually and collectively how business stakeholders such as customers, known users and unidentifiable traffic interact with the web presence.
Understand both individually and collectively how recipients respond to e-mail communications.
Provide insight into how website visitors are making use of a website as well as demonstrate the value of the visitor traffic and their actions relating to the website.
Demonstrate the advertising value of a website.
The ability to identify sales opportunities via the website and email communication.
Have an early warning system that identifies increased or decreased website interactivity (Effective website success measurement).
Assistance in identifying customers who are most likely to respond to business offers.
Insights into how defined user groups (customers etc.), or identified individuals are interacting with web content.
The ability to respond quickly and effectively to insights gauged from web interactivity.
The availability of the above insights throughout the organisation, e.g. sales, marketing, customer care, training, management etc. With the ability to export and intergrate the information with other business information systems.
Assistance in streamlining costs and improving customer communications.
Improved measurability and management of the sales, communication and marketing processes.

In meeting these needs, the present invention provides the following key web interaction functions:
The ability to identify and track individual website visitors and group visitors such as customers or groups of customers to see how they interact with the web presence individually and collectively. (Click stream path and response to campaigns)
The ability to link email communications to web interactivity in order to gauge individual responses.
Extensive analysis and segmentation capabilities to provide effective business intelligence relating to the website (both identified and unidentified users).
Website interaction history based on contact category groups and individual users. Quickly and easily identify who has or has not interacted with the web presence or a specific section/page of the site based on visitor identification and grouping.
Provides a communication management facility by allowing organisations to establish their outward-bound email communications requirements.
Provides a business with a facility to manage user identification as well as providing users with a facility to opt-out from the visitor identification and tracking process.

1. A method of collecting data regarding a plurality of web pages visited by at least one user, the method comprising the steps of:
receiving, at a server, identification data together with web page data, wherein the identification data identifies a website access device of a user and the web page data identifies a web page which the user has requested to view using the website access device;
storing the identification data arid the web page data in a database;
storing personal data of a plurality of users, the personal data including a unique identifier of each user;
receiving a request from a user to view a web page, the request including a unique identifier of the user and identification data identifying the website access device used by the user; and
using the unique identifier and identification data from the request to retrieve the user's personal data and to link the web page data to the user.

2. A method according to claim 1 wherein the unique identifier is at least one of a users name, e-mail address or a unique identifier generated for the user.

3. A method according to claim 1 wherein the request from the user is generated from an email communication or identifiable interaction with the website.

4. A method according to claim 3 wherein the interaction with the website is the completing of an online form or the requesting of a web page through a website access device or internet browser.

5. A method according to claim 1 further comprising sending an e-mail to a plurality of users, the e-mail including a link to further information available within the e-mail or alternatively a requested web page therein, wherein the request from the user to view the information or requested web page is generated by the user selecting the link.

6. A method according to claim 5 wherein once the user has selected the link, the user's request is routed first to the server before being redirected to the requested web page or alternatively information relating to clicking on the link is shared with the server.

7. A method according to claim 1 wherein a tracking script is inserted into the code of a web page to communicate identification data and/or unique identifier data to the server.

8. A method according to claim 1 further comprising the step of redirecting the user to the requested web page.

9. A method according to claim 1 comprising the step of providing a user with the capability to verify if their interactions with a website are being tracked as an identifiable user and accordingly opt out from the identification and tracking process.

10. A method according to claim 1 wherein a plurality of website access devices are associated with a single individual and therefore provide collective web page data on the individual.
